(19) United States
(12) Patent Application Publication
(10) Pub. No.: US 2023/0389496 A1
(43) Pub. Date: Dec. 7, 2023

(54) MOBILE AEROPONIC GROW SYSTEM

(71) Applicant: URBAN AGRICULTURE INNOVATIONS, LLC, Dayton, OH (US)

(72) Inventor: Leanora M. Royster, Dayton, OH (US)

(21) Appl. No.: 18/329,355

(22) Filed: Jun. 5, 2023

Related U.S. Application Data
(60) Provisional application No. 63/348,708, filed on Jun. 3, 2022.

(51) Int. Cl. A01G 31/06

(52) U.S. Cl. CPC A01G 31/06

(57) ABSTRACT

The present disclosure relates to a mobile horizontal aeroponic vegetable grow system. The aeroponic system is energy efficient, affordable, and easy to use. The mobile indoor gardening system is configured for people living in a food desert without sufficient yard space to garden and/or have limited resources. The system can include a first container, a second container, a frame, and a cover. The first container and the second container can grow plants, fruits, and a vegetables aeroponically.

### CROSS-REFERENCE TO RELATED APPLICATIONS

This application claims the benefit of U.S. Provisional Application No. 63/348,708, filed on Jun. 3, 2022. The entire disclosure of the above application is incorporated herein by reference.

### FIELD

The present technology relates to aeroponic plant systems, and more particularly to a mobile aeroponic system.

### INTRODUCTION

This section provides background information related to the present disclosure which is not necessarily prior art.

The commercial cultivation of plants in enclosed spaces is well known. Greenhouses and warehouses are used to cultivate and grow plants for commercial use. Such use of these enclosed spaces can extend the growing seasons of the plants being cultivated and can permit additional growing cycles per year by way of controlling the growing environment, utilizing mechanical or otherwise artificial means for lighting, watering, and nutrient application to the plants. It is also of interest to maintain certain atmospheric conditions for plants, including humidity levels, temperature control, and levels of oxygen and carbon dioxide.

There are also commercial demands in obtaining the freshest available, locally grown produce and other commercially grown plants. Ways to achieve the highest possible levels of food safety and food security, ways to provide easy and immediately accessible plants, including those located in urban or rural settings, are also of interest. Satisfying these needs has historically been a challenge due to the nature of growing crops at commercial scale and the need for substantial space associated with doing so.

Various plant growing technologies including soil-less growing using aeroponics, hydroponics, and/or aquaponics. The components of these respective technologies allow for the commercial cultivation of plants in virtually any indoor or sheltered environment located in virtually any location. However, there continues to be a need for adapting suitable systems and enclosures for use in the agricultural industry for providing controlled plant growing environments. Certain plant growing technologies and systems, furthermore, are not well suited for an individual to use for household use.

Accordingly, there is a need for a mobile aeroponic grow system for individual household use.

### SUMMARY

In concordance with the instant disclosure, a mobile aeroponic grow system for individual household use, has surprisingly been discovered.

The present disclosure provides an aeroponic grow system including a first container, a second container, a frame, and a cover. The first container can include a first lid, a first manifold, a first plurality of plant baskets, a first water pump, a first oxygenation means, and a first shut off valve. The first manifold, the first water pump, and the first oxygenation means can be disposed in and housed by the first container. The first lid can be configured to enclose the first container. The first shut off valve can intersect a sidewall of the first container. Similarly, the second container can include a second lid, a second manifold, a second plurality of plant baskets, a second water pump, a second oxygenation means, and a second shut off valve. The second manifold, the second water pump, and the second oxygenation means can be disposed in and housed by the second container. The second lid can be configured to enclose the second container. The second shut off valve can intersect a sidewall of the second container. The frame can be configured to house the first container and the second container. The cover can be configured to enclose the first container, the second container, and the frame.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exploded view of a first container of an aeroponic grow system;

FIG. 2 is an exploded view thereof;

FIG. 3 is an exploded view a second container an aeroponic grow system;

FIG. 4 is an exploded view thereof;

FIG. 5 is a top plan view of the first container without a lid installed thereon;

FIG. 6 is a partial cutaway front elevational view of the first container with the lid installed thereon;

FIG. 7 is a top perspective view of the first container and the second container on a frame; and

FIG. 8 is a top perspective view of the aeroponic grow system with a cover installed thereon, the cover having a door for accessing an interior of the aeroponic grow system.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

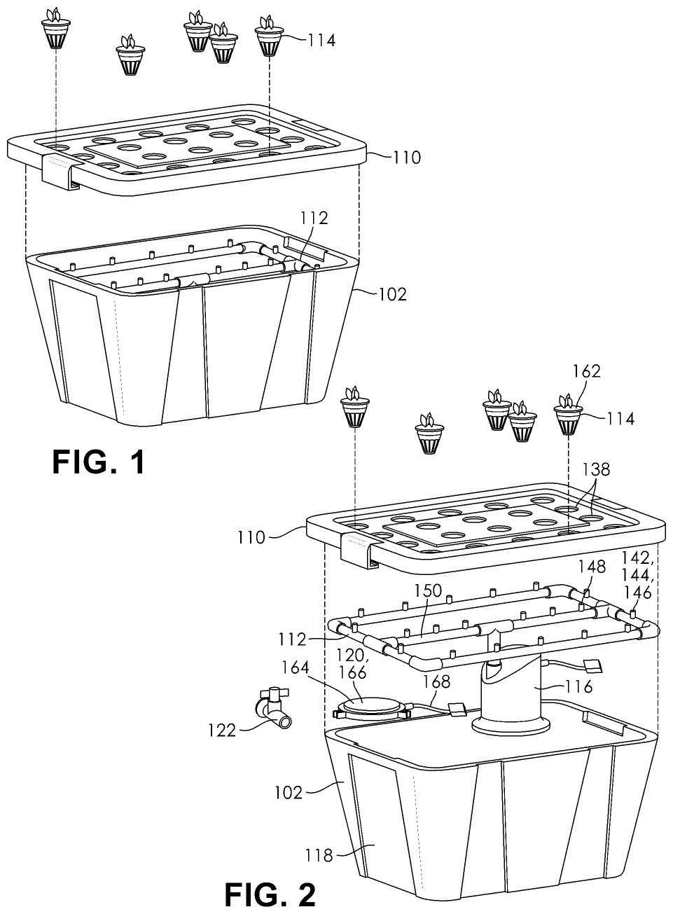

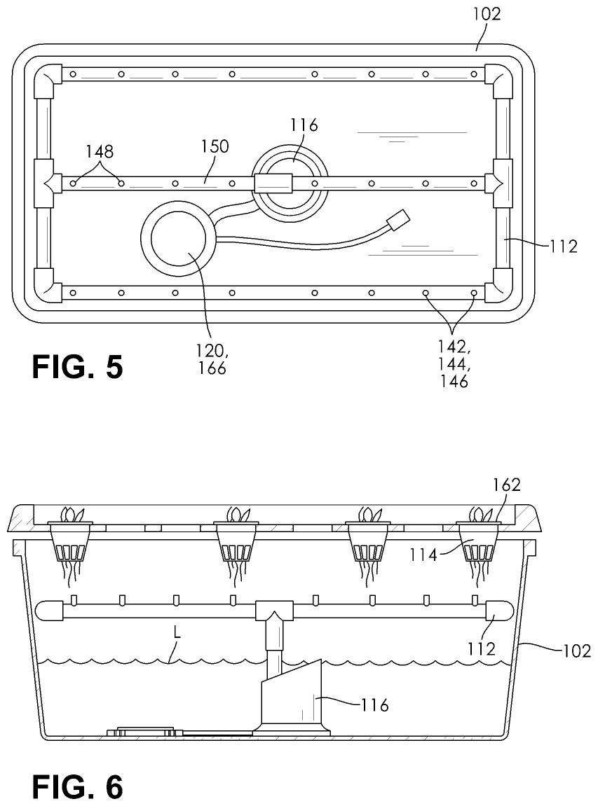

The present disclosure provides a mobile aeroponic grow system 100 for growing plants, shown generally in FIGS. 1-8. The aeroponic grow system 100 can include a first container 102, a second container 104, a frame 106, and a cover 108. Advantageously, the aeroponic grow system 100 provides a portable and self-contained means for aeroponically growing plants. It should be noted that an aeroponic grow system 100 involves growing plants without the use of soil. Instead of using soil, the system 100 relies on air to deliver a nutrient-rich liquid, in the form of an aerosolized mist, to the roots of the plant. Advantageously, aeroponics provides crops with much stronger and healthier root systems. Therefore, the aeroponic grow system 100 can provide increased plant growth performance compared to a standard hydroponic system.

As shown in FIGS. 1-4, the first container 102 can include a first lid 110, a first manifold 112, a first plurality of plant baskets 114, a first water pump 116, a first oxygenation means 120, and a first shut off valve 122. The first manifold 112, the first water pump 116, and the first oxygenation means 120 can be disposed in and housed by the first container 102. The first lid 110 can be configured to enclose the first container 102. The first shut off valve 122 can intersect a sidewall 118 of the first container 102. Similarly, the second container 104 can include a second lid 124, a second manifold 126, a second plurality of plant baskets 128, a second water pump 130, a second oxygenation means 134, and a second shut off valve 136. The second manifold 126, the second water pump 130, and the second oxygenation means 134 can be disposed in and housed by the second container 104. The second lid 124 can be configured to enclose the second container 104. The second shut off valve 136 can intersect a sidewall 132 of the second container 104.

With continued reference to FIGS. 1-4, the first container 102 and the second container 104 can be formed from a solid material. The solid material can allow for the first container 102 and the second container 104 to be stable and durable as the plants within each container grow. As non-limiting examples, the containers 102, 104 can be formed from various polyolefins and mixtures thereof, polypropylene, high density polyethylene (HDPE), and/or polyethylene terephthalate (PET). A skilled artisan can select other suitable materials for forming the containers 102, 104 within the scope of the present disclosure. Further, the containers 102, 104 can be opaque in color to militate against light from shining upon the roots of the plants as they grown within the containers 102, 104. A skilled artisan can select a color and opacity for the container 102,104 to promote plant growth within the scope of the present disclosure.

With particular reference to FIGS. 1-2, the first lid 110 can include a first plurality of openings 138 and the second lid 124 can include a second plurality of openings 140. The first plurality of openings 138 can receive a first plurality of plant baskets 114 and the second plurality of openings 140 can receive the second plurality of plant baskets 128. In an exemplary embodiment shown in FIGS. 1-2, the first plurality of openings 138 can include up to twenty (20) openings and therefore, the first lid 110 can hold up to twenty (20) plant baskets 114 and twenty plants. As a non-limiting example, each of the first plurality of openings 138 can be about 2 inches in diameter to hold a plant basket with a diameter of about 2 inches. A skilled artisan can select a suitable opening size for each of the first plurality of openings 138 within the scope of the present disclosure.

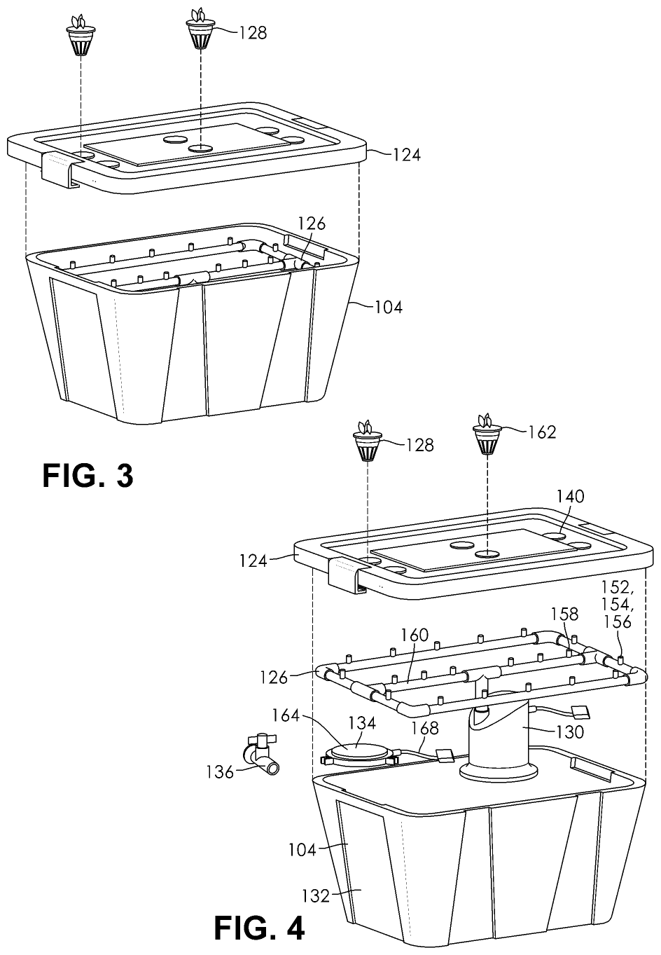

With renewed reference to FIGS. 3-4, the second plurality of openings 140 can include up to six (6) openings and therefore, the second lid 124 can hold up to six (6) plant baskets 128 and six plants. As a non-limiting example, each of the second plurality of openings 140 can be about 3 inches in diameter to hold a plant basket 128 with a diameter of about 3 inches. Desirably, the second container 104 is equipped to hold larger plants such as larger fruits or vegetables. A skilled artisan can select a suitable opening size for each of the second plurality of openings 140 within the scope of the present disclosure. It should also be noted that the openings 138, 140 can be spaced equidistantly on the lid to promote optimum plant growth. A skilled artisan can select an optimum configuration and distance between each of the openings 138, 140 to promote optimum growth of the plants within the scope of the present disclosure.

As shown in FIGS. 1-4, the first container 102 can include the first manifold 112. Similarly, the second container 104 can include the second manifold 126. Each manifold 112, 126 can be formed of a solid material such as polyvinyl chloride, as a non-limiting example. A skilled artisan can select a suitable material for the manifold 112, 126 within the scope of the present disclosure. Each manifold 112, 126 can be sized to fit within their respective containers 102, 104 and allow for the lid 110, 124 of the container 102, 104 to be secured to the container 102, 104. In one exemplary embodiment shown in FIG. 6, the manifold 112, 126 can be suspended within the container 102, 104 by the water pump 116, 130. A skilled artisan can select a suitable distance between the lid 110, 124 and a bottom surface of the container 102, 104 to suspend the manifold 112, 126 such that the roots of the plants are adequately watered by the manifold 112, 126.

With renewed reference to FIG. 2, the first manifold 112 can include a first plurality of sprayers 142 disposed around the perimeter of the first manifold 112. As an example, the sprayers 142 can include aero-misters 144 and, more specifically, can include micro aero-misters 146. Advantageously the micro aero-misters 146 provide a lower pressure application of liquid to delicate roots and, in operation, the sprayers 142 surround the roots and ensure even saturation of a desired nutrient solution on the suspended roots. As a non-limiting example, the first manifold 112 can include up to twenty-four (24) 180-degree micro aero misters around the perimeter of the first manifold 112. The first manifold 112 can also include first supplemental sprayers 148 disposed on a middle support 150 of the first manifold 112, shown in FIG. 2. The first supplemental sprayers can include sixteen (16) 380-degree micro aero misters. Desirably, the larger spray radius of the first supplemental sprayers 148 can allow for a greater number of roots to be watered in the open space of the middle of the first container 102. It should be appreciated that the sprayers 142,148 can be placed in a configuration along the first manifold 112 to promote even watering of the plants and can be spaced equidistantly along the first manifold 112.

With further reference to FIG. 4, the second manifold 126 can include a second plurality of sprayers 152 disposed around the perimeter of the second manifold 126. As an example, the sprayers 152 can include aero-misters 154 and, more specifically, can include micro aero-misters 156. Advantageously the micro aero-misters 156 provide a lower pressure application of liquid to delicate roots and, in operation, the sprayers 152 surround the roots and ensure even saturation of a desired nutrient solution on the suspended roots. As a non-limiting example, the second manifold 126 can include up to fourteen (14) 180-degree micro aero misters around the perimeter of the second manifold 126. The second manifold 126 can also include second supplemental sprayers 158 disposed on a middle rod 160 of the second manifold 126, shown in FIG. 4. The second supplemental sprayers 158 can include six (6) 380-degree micro aero misters. Desirably, the larger spray radius of the second supplemental sprayers 158 can allow for a greater number of roots to be watered in the open space of the middle of the second container 104. It should be appreciated that the sprayers 152,158 can be placed in a configuration along the second manifold 126 to promote even watering of the plants and can be spaced equidistantly along the second manifold 126.

As shown in FIGS. 1-4, the first container 102 and the second container 104 can include the first plurality of plant baskets 114 and the second plurality of plant baskets 128, respectively. The plant baskets 114, 128 can be configured to be disposed within the openings 138, 140 and configured to suspend the plants for aeroponic growth. It should be noted that the plant baskets 114, 128 can be removable and transferrable between different aeroponic grow systems 100. The number of plant baskets 114, 128 disposed within the first container and the second container can correspond to the number of openings of the lid of the first container 102 and the second container 104. As a non-limiting example, as the first container 102 includes twenty openings, the first container 102 can include twenty plant baskets 114 and therefore, grow up to twenty plants. Further, the diameter of the plant baskets 114,128 can range from about 2 inches to about 3 inches, as an example. Additionally, it should be noted that the first plurality of plant baskets 114 and the second plurality of plant baskets 128 can be different in number and in size. Alternatively, the first plurality of plant baskets 114 and the second plurality of plant baskets 128 can be similar in number and in size. The plant baskets 114, 128 can also include a collar 162, formed of neoprene, as an example, to support the plant within the plant basket 114, 128 and further prevent light intrusion into the first container 102 or second container 104. A skilled artisan can select the number, size, and material for the plant basket 114,128 within the scope of the present disclosure.

With reference to FIGS. 2 and 5-6, the first container 102 can include a first water pump 116 configured to pump water into the first manifold 112 from the bottom of the first container 102. Similarly, the second container 104 can include a second water pump 130 configured to pump water into the second manifold 126 from the bottom of the second container 104. The water pumps 116, 130 can include a mesh cover. Advantageously, the mesh cover can prevent root clogging. The water pump 116, 130 can also be connected to a timer that can be programmed to start and/or stop the water pump 116, 130 at set intervals of time. A skilled artisan can select a suitable time interval for the water pump 116, 130 within the scope of the present disclosure. As a non-limiting example, the water pump 116, 130 can be a 600 GPH submersible bottom suction water pump. A skilled artisan can select a suitable water pump 116,130 within the scope of the present disclosure.

As shown in FIGS. 1-6, the first container 102 and the second container 104 can include a first oxygenation means 120 and a second oxygenation means 134, respectively. The oxygenation means 120, 134 can be configured to oxygenate the first container 102 and the second container 104, respectively. As a non-limiting example, the oxygenation means 120, 134 can include an air pump 164, an air stone bubble diffuser 166, and tubing 168 that couples the air pump 164 and the air stone bubble diffuser 166. Specifically, the air pump 164 can include a 125 GPH air pump and the air stone bubble diffuser 166 can include a 4″ air stone disk bubble diffuser. A skilled artisan can select a suitable oxygenation means 120, 134 within the scope of the present disclosure. The oxygenation means 120, 134 can operate continuously in order to ensure the oxygenation of the first container 102 and the second container 104, even when the water pump 116, 130 is dormant. It should be noted that the more oxygen that is in the system, the less nutrient solution is required for optimum plant growth, especially for organic gardens. To this point, continuous oxygenation can reduce the amount of nutrient solution required and, advantageously, reduce the cost required for optimum plant growth.

As shown in FIG. 6, the liquid level (L) can be above the oxygenation means 120, 134 and water pump 116, 130 pick up to allow for the oxygenation means 130, 134 to oxygenate the liquid and for the water pump 116, 130 to pick up the liquid to push into the manifold 112, 126 and through the sprayers 142, 152. However, as the system 100 is aeroponic, the liquid level (L) should remain below the plant roots and the manifold 112, 126 to militate against the roots coming into contact with and soaking in liquid. Alternatively, the aeroponic nature of the system 100 allows for the roots to be misted by the sprayer 142, 152 with the liquid to acquire nutrients and water.

With continued reference to FIG. 2, the first container 102 can include the first shut off valve 122 configured to drain liquid from the first container 102. Similarly, the second container 104 can include the second shut off valve 136 configure to drain liquid from the second container 104. Each of the shut off valves 122, 136 can intersect a sidewall of their respective container 102, 104. Advantageously, the shut off valve 122, 136 can allow for easy maintenance by allowing the user to drain the first container 102 and the second container 104 and prevent liquid from pooling and saturating the roots. In operation, when liquid must be drained, the container 102, 104 can be connected to either a hose or drain in a bucket, as desired. The shut off valve 122,136 can be used to eliminate the need to open the lid 110,124 of the container 102,104, thereby exposing roots to light or disturbing healthy roots.

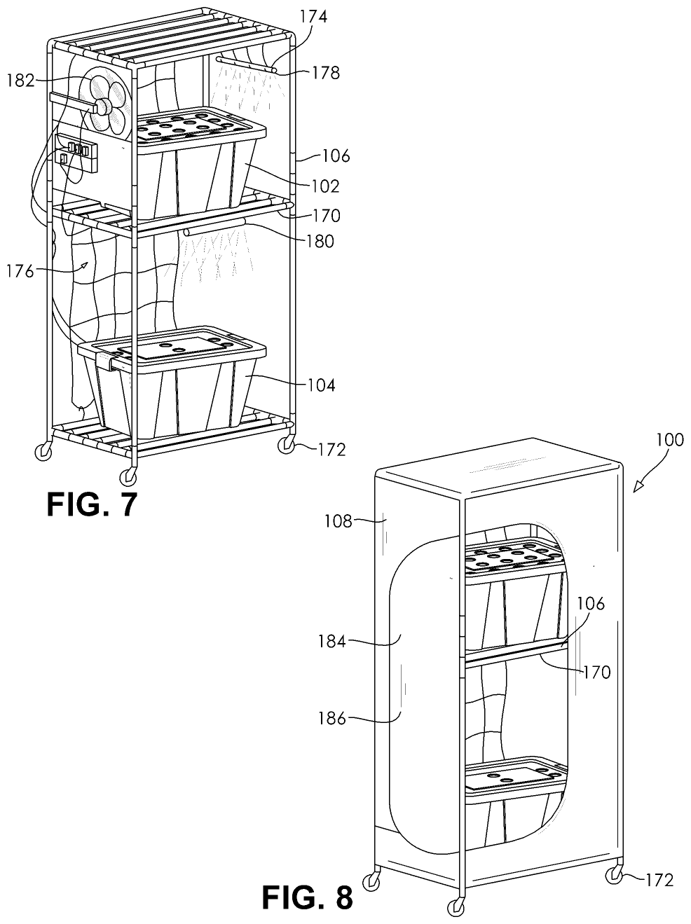

With reference to FIG. 7, the frame 106 can be configured to house the first container 102 and the second container 104. The frame 106 can be formed from a solid material. The solid material can allow for the frame 106 to be stable and durable as the plants within each container 102, 104 grow. As non-limiting examples, the frame 106 can be formed of polyvinyl chloride (PVC), or another rust-proof material. A skilled artisan can select other suitable materials for forming the frame 106 within the scope of the present disclosure.

The frame 106 can be rectangular in shape and can include an adjustable middle shelf 170. The middle shelf 170 therefore creates two chambers, one for holding the first container 102 and another for holding the second container 104. Advantageously, the adjustable nature of the middle shelf 170 can allow for the user to adapt the frame 106 as plants grow. The frame 106 can further include locking wheels 172 that allow for a user to easily move the aeroponic grow system 100. For example, the user can use the wheels 172 to move the aeroponic grow system 100 from one area of a kitchen to another area of kitchen for inventory or cooking purposes. Desirably, the wheels 172 allow for the aeroponic grow system to be portable from one location to another. Additionally, the locking wheels 172 can militate against the system from moving when the aeroponic grow system 100 is in use either during planting, harvesting, or maintenance. A skilled artisan can select a suitable number and size of wheels 172 for the aeroponic grow system 100 to promote easy movement within the scope of the present disclosure.

With continued reference to FIG. 7, the frame 106 can include a mounting rod 174 disposed on the frame 106 to allow for the user to couple accessories, such one or more lights, fans, surge protectors, and/or plant nutrients, to the frame 106. The frame 106 can include hooks disposed along the side of the frame to allow for hanging items that can aid with plant growth, such as CO₂ bags or pest retardants, from the frame 106. The frame 106 can further include trellis netting 176 coupled to the mounting rod 174 to allow plants that grow on a vine and require support for growth, such as green beans, peas, and cucumbers. The trellis netting 176 can also be used to secure weighted vegetables, such as tomatoes, peppers, and squash.

As referenced above and shown in FIG. 7, the frame 106 can include an LED light 178 to promote plant growth. It should be noted that certain LED lights 178 can mimic natural sunlight required by plants at various stages of growth. In one exemplary embodiment, the LED light 178 can include energy efficient 20-watt lights that generate low heat to militate against the aeroponic grow system 100 becoming too hot and damaging the plants. As described above, the LED lights 178 can be coupled to or function as the mounting rod 174 of the frame 106 and can be directed toward the containers 102, 104 to promote plant growth. In order for the plants in both the first container 102 and the second container 104 to both receive light, the frame 106 can include an LED light 178 on the mounting rod 174 as well as a second LED light 180 underneath the middle shelf 170. Additionally, the separate LED lights 178, 180 on the mounting rod 174 and under the middle shelf 170 can be used separately when less light is required by one container 102, 104. It should be noted that seedlings require less light, approximately 2800 lumens, than the vegetative state when plants need more intense light, approximately 5770 lumens. Additionally, the LED lights 178, 180 can be controlled by a timer to be set, as desired, to allow for the user to time when the LED lights 178, 180 are on. A skilled artisan can select suitable LED lights 178, 180 and a suitable configuration for the LED lights 178, 180 to promote growth within the scope of the present disclosure. As referenced above, the frame 106 can include a fan 182 to promote continuous air circulation within the aeroponic grow system, if desired. The fan 182 can be a 6-inch 2-speed 25-watt oscillating fan, as an example.

It should be noted that a surge protector can be mounted to the outside of the frame using a particle board coupled to the frame. The components, such as the water pump 116, 130 and air pump 164 of each container 102, 104, can be connected to the surge protector corresponding to each container 102, 104 to run the air pump 164 and water pumps 116, 130 continuously. For example, the aeroponic grow system 100 can be grounded by a 6 ft AC cord with 12 outlets and 4 USB ports controlled by an on and off switch. As such, only a single wall plug may be necessary for the aeroponic grow system.

With reference to FIG. 8, the cover 108 can be configured to enclose the first container 102, the second container 104, and the frame 106. Advantageously, the cover 108 creates a self-contained system 100. The cover 108 can be constructed using a pliable material to allow for the cover 108 to move easily over the frame 106. The cover 108 can also have an internal lining of a different material than the cover itself. For example, the cover 108 can include a mylar lining 184. Advantageously, the mylar lining 184 can block light from escaping and can also provide an efficiency boost to the LED lights 178,180. As a non-limiting example, the mylar lining 184 can be a 600 D reflective mylar lining 184. The cover 108 can also include a door 186 configured to be opened and closed. The door 186 allows for the user to easy access to the growing plants. The door 186 can be secured using a fastener, such as a zipper or hook and loop fastener. The door 186 can further include a netting layer configured to militate against patrons or public from touching food to be used by cooks while in commercial use.

In operation, the user can assembly the aeroponic grow system 100 by constructing the frame 106 and assembling the manifold 112, 126, the plant baskets 114, 128, the water pump 116, 130, the oxygenation means 120, 134, and shut off valve 122, 136 in each of the first container 102 and the second container 104. The user can place the first container 102 and the second container 104 on different shelves of the frame 106. The accessories, such as the trellis netting 176 and the LED lights 178, 180 can be coupled to the frame 106 and plugged in. The water pumps 116, 130 can also be plugged in to provide power to the pumps 116, 130. Plants can be added to the plant baskets 114,128 and the entire frame can be enclosed with the cover. Nutrient liquid can be added to each to each container 102, 104 and a timer controlling the water pumps 116, 130 can be activated to mist the plant roots at a predetermined interval or schedule.

Advantageously, the aeroponic grow system 100 of the present disclosure provides users with the ability to grow plants, fruits, and vegetables within a small place that lacks outdoor space. For example, a user living in an apartment that lacks a balcony could grow a variety of plants, fruits, and vegetables without worrying about how the plants will obtain sunlight and nutrients or, due to the self-contained nature of the system 100, without worrying about creating a mess in a small space. Additionally, the portable nature of the system 100 allows for the system 100 to be wheeled away into a corner while the plants, fruits, and vegetables are growing and then to be wheeled back into the living space, such as the kitchen, when the system 100 requires maintenance or it is time to harvest what has grown. The system 100 can further be used to protect growing plants from other environments and/or to isolate or quarantine certain growing plants from other environments.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A mobile aeroponic grow system for growing plants, comprising:
a first container including:
a first lid including a first plurality of openings;
a first manifold including a first plurality of sprayers disposed around the perimeter of the first manifold;
a first plurality of plant baskets configured to be disposed within the first plurality of openings and configured to suspend the plants;
a first water pump disposed within the first container and configured to pump liquid into the first manifold;
a first oxygenation means disposed within the first container and configured to oxygenate the first container;
a first shut off valve intersecting a sidewall of the first container and configured to drain liquid from the first container;
a second container including:
a second lid having a second plurality of openings;
a second manifold including a second plurality of sprayers disposed around the perimeter of the manifold;
a second plurality plant baskets configured to be disposed within the second plurality of openings;
a second water pump disposed within the second container and configured to pump liquid into the second manifold;
a second oxygenation means disposed within the second container and configured to oxygenate the second container;
a second shut off valve disposed within the second container and configured to drain liquid from the second container;
a frame configured to house the first container and the second container; and
a cover configured to enclose the first container, the second container, and the frame.

2. The mobile aeroponic grow system of claim 1, wherein the first container and the second container are opaque.

3. The mobile aeroponic grow system of claim 1, wherein the first plurality of openings includes twenty openings.

4. The mobile aeroponic grow system of claim 1, wherein each of the first plurality of openings is 2 inches in diameter.

5. The mobile aeroponic grow system of claim 1, wherein the first plurality of sprayers include aero-misters.

6. The mobile aeroponic grow system of claim 5, wherein the first plurality of sprayers includes micro aero-misters.

7. The mobile aeroponic grow system of claim 1, wherein the first manifold includes first supplemental sprayers disposed on a middle support of the first manifold.

8. The mobile aeroponic grow system of claim 1, wherein the second plurality of openings includes six openings.

9. The mobile aeroponic grow system of claim 1, wherein each of the second plurality of openings is 3 inches in diameter.

10. The aeroponic grow system of claim 1, wherein the second plurality of sprayers includes aero misters.

11. The mobile aeroponic grow system of claim 10, wherein the second plurality of sprayers includes micro aero-misters.

12. The mobile aeroponic grow system of claim 1, wherein the second manifold includes second supplemental sprayers disposed on a middle support of the second manifold.

13. The mobile aeroponic grow system of claim 1, wherein the first oxygenation means and the second oxygenation means each include an air stone.

14. The mobile aeroponic grow system of claim 1, wherein the frame includes an LED light.

15. The aeroponic grow system of claim 14, wherein the frame includes a first LED light configured to light the plants of the first container.

16. The mobile aeroponic grow system of claim 15, wherein the frame includes a second LED light configured to light the plants of the second container.

17. The mobile aeroponic grow system of claim 1, wherein the frame includes a mounting rod configured to hold at least one of a hanging nutrient bag and a trellis netting.

18. The mobile aeroponic grow system of claim 1, wherein the frame includes a fan configured to circulate air within the mobile aeroponic grow system.

19. The mobile aeroponic grow system of claim 1, wherein the cover includes a mylar lining.

20. The mobile aeroponic grow system of claim 1, wherein the cover is configured to be opened and closed with a fastener.
